(19) United States
(12) Patent Application Publication
(10) Pub. No.: US 2023/0349060 A1
(43) Pub. Date: Nov. 2, 2023

(54) METHOD FOR OPERATING AN ELECTROLYSIS SYSTEM, AND ELECTROLYSIS SYSTEM

(71) Applicant: Siemens Energy Global GmbH & Co. KG, Munich, Bayern (DE)

(72) Inventors: Thomas Purucker, Hessdorf (DE); Erik Wolf, Röttenbach (DE)

(73) Assignee: Siemens Energy Global GmbH & Co. KG, Munich, Bayern (DE)

(21) Appl. No.: 18/025,899

(22) PCT Filed: Jul. 28, 2021
(86) PCT No.: PCT/EP2021/071131

§ 371 Date: Mar. 12, 2023

(30) Foreign Application Priority Data
Sep. 16, 2020 (EP) 20196417.8

(51) Int. Cl. C25B 15/029; C25B 1/04; C25B 15/08

(52) U.S. Cl. CPC C25B 15/029; C25B 1/04; C25B 15/085; C25B 15/083

(57) ABSTRACT

A method for operating an electrolysis system which includes an electrolyzer for generating hydrogen and oxygen as product gases, the product gas streams being discharged from the electrolyzer. A secondary gas is mixed with at least one of the product gas streams with the goal of reducing the foreign gas concentration in the product gas stream to be treated by an increase of the overall volume flow.

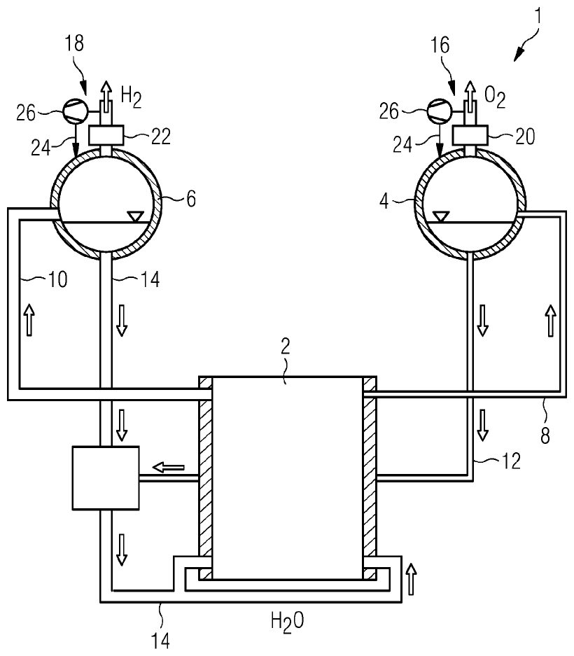

### CROSS REFERENCE TO RELATED APPLICATIONS

This application is the US National Stage of International Application No. PCT/EP2021/071131 filed 28 Jul. 2021, and claims the benefit thereof. The International Application claims the benefit of European Application No. EP20196417 filed 16 Sep. 2020. All of the applications are incorporated by reference herein in their entirety.

### FIELD OF INVENTION

The invention relates to a method for operating an electrolysis system comprising an electrolyzer for generating hydrogen and oxygen as product gases, wherein the product gas streams are discharged from the electrolyzer. The invention further relates to an electrolysis system comprising an electrolyzer for generating hydrogen and oxygen as product gases and at least one product gas line for discharging the product gases from the electrolyzer, wherein a gas separation device is arranged on the at least one product gas line.

### BACKGROUND OF INVENTION

Nowadays, hydrogen is produced for example by means of PEM electrolysis. One component of a PEM electrolysis cell is a proton-permeable polymer membrane (proton exchange membrane) that is contacted on both sides by porous platinum electrodes (anode and cathode). An external voltage is applied thereto and water is fed to the anode side of the electrolyzer. The catalytic effect of the platinum causes the water on the anode side to decompose. This forms oxygen, free electrons and positively charged hydrogen ions H+. The hydrogen ions H+ diffuse through the proton-conducting membrane to the cathode side, where they combine with the electrons from the external circuit to form hydrogen molecules H2.

The electrolysis cells described above are combined in stacks. Water is introduced into the stack, which is under DC voltage, and after passage through the electrolysis cells two product streams emerge, consisting of water and gas bubbles as oxygen or hydrogen. It is inherent to the system here that in the product stream of the one product gas, the respective other product gas is present only in small amounts. In practice, small amounts of hydrogen are present in the oxygen gas stream and small amounts of oxygen are present in the hydrogen gas stream. The quantity of the respective foreign gas depends on the electrolysis cell design and also varies under the influence of current density, catalyst composition, aging and, in the case of a PEM electrolysis system, the membrane material. It may be necessary under some circumstances to reduce the foreign gas concentration, specifically already immediately at or directly after the electrolysis cell or the electrolysis stack, for example in a gas separation device downstream of the electrolyzer.

### SUMMARY OF INVENTION

In order to solve the problem described above, in particular both product gas streams are fed to a respective, catalytically activated recombiner in which a catalyst allows the hydrogen to recombine with the oxygen, with the result that the respective product stream recombines into water. To this end, it is necessary to heat the gas stream beforehand to at least 80° C. so that the conversion rates of the recombiner are sufficiently high.

A further possibility for dealing with the foreign gas problem is to produce recombination-active surfaces within the electrolysis cell using specific treatment measures, which however may be economically disadvantageous.

The invention is therefore based on the object of proposing a novel method for reducing the foreign gas in a product gas stream of a hydrogen electrolysis system.

The object is achieved according to the invention by a method for operating an electrolysis system comprising an electrolyzer for generating hydrogen and oxygen as product gases, wherein the product gas streams are discharged from the electrolyzer and wherein a secondary gas is mixed with at least one of the product gas streams.

The electrolysis system may here be a high-pressure electrolysis system or a low-pressure electrolysis system that is configured for PEM electrolysis or for alkaline electrolysis.

“Product gas” refers here to the oxygen or hydrogen produced in the electrolysis system. “Product gas stream” is understood to mean the oxygen-side or hydrogen-side stream that, in addition to the respective product gas, may inter alia also comprise further components, for example water or the respective foreign product gas.

The invention is based on the concept of supplying an additional gas stream comprising the secondary gas, either provided externally or originating from the internal production of the electrolysis system, with the aim of reducing the foreign gas concentration in the product gas stream to be treated by increasing the overall volumetric flow rate. The secondary gas may be supplied at multiple points in the electrolysis system, for example in a gas separation device and/or in the outlet region of the electrolysis stack and/or in the inlet region of the electrolysis cell. Depending on the position of the supply point, the secondary gas mixes with product gas either immediately or later when the product gas is produced. Depending on the electrolysis cell construction, the method according to the invention is essential for trouble-free and reliable operation of the electrolysis system and constitutes a technical measure that does not require any aging-relevant and efficiency-relevant changes to the electrolysis cell.

According to a preferred embodiment, the secondary gas comprises the same product gas as in the product gas stream with which it is mixed and/or it comprises an inert gas. The inert gas is provided particularly for the oxygen product side. Adding inert gas and/or additional oxygen into the oxygen-side product gas stream reduces the relative concentration of back-diffused hydrogen. On the hydrogen product side, the secondary gas consists in particular of hydrogen.

According to a further preferred embodiment, the secondary gas is a gas which is generated in the electrolysis system and is purified and recycled. This means that only oxygen is used as secondary gas on the oxygen product side and/or only hydrogen is used as secondary gas on the hydrogen product side. This embodiment has the significant advantage that no external gas needs to be provided or stored for use in the electrolysis system.

Preferably, at least part of the product gas stream is purified after a gas separation device and used as secondary gas. “Gas separation device” is understood here to mean a liquid/gaseous-phase separator for gas separation. This procedure requires minimal structural outlay by branching off part of a product gas generated during the electrolysis after the gas separation device and recycling it into the electrolysis system.

Preferably, the secondary gas is recycled into the gas separation device under pressure, i.e. the pressure of the secondary gas is at least higher than the pressure in the gas separation device. To increase the pressure, use is in particular made of a fan or a compressor.

With a view to operating the electrolysis system as flexibly and precisely as possible, advantageously a foreign gas concentration in the product gas stream which is mixed with the secondary gas is determined and the volumetric flow rate of the secondary gas is adjusted depending on the foreign gas concentration. The foreign gas concentration may be determined mathematically or via measurements by means of gas sensors. In particular, the gas sensors measure the distance from the ignition limit for example by way of the thermal conductivity. The degree of the foreign gas concentration and thus the amount of the secondary gas supply required can be determined and adjusted in an optimized manner by way of a differential temperature measurement across the recombiner. Alternatively, the gas composition may also be determined by way of thermal conductivity, speed of sound and gas chromatographs. By way of example, the foreign gas concentration is determined on the outlet side of the gas separation device.

Preferably, at least part of a product gas is branched off and temporarily stored in a gas store, wherein the stored product gas is recycled as secondary gas when the electrolysis system is started up. The branching-off is effected for example from the or after the gas separation device. The product gas is also purified, for example in a recombiner. In order to be able to start the electrolysis system, the purified product gas is recycled at a point in time at which the recycling of the product gases is not yet active, since no product gases have been produced yet, and mixed with the product gas stream.

The object is further achieved according to the invention by an electrolysis system comprising an electrolyzer for generating hydrogen and oxygen as product gases, at least one first product gas line and one second product gas line for discharging the product gases from the electrolyzer, wherein a secondary gas line is provided, by means of which a secondary gas is mixed with at least one of the product gas streams in one of the product gas lines. The advantages and preferred configurations already stated in relation to the method can be applied to the electrolysis system in a corresponding manner.

The secondary gas line preferably opens here into a gas separation device downstream of the electrolyzer. The secondary gas line is preferably branched off from the at least one product gas line after the gas separation device. For the purification of the product gas before it is recycled as secondary gas, a recombiner is preferably arranged on the at least one product gas line. Furthermore, the secondary gas line expediently comprises a fan. According to a preferred configuration, the electrolysis system additionally comprises a measuring device for measuring a foreign gas concentration in the product gas stream which is mixed with the secondary gas, and a control device suitable for adjusting the volumetric flow rate of the secondary gas depending on the foreign gas concentration. According to a further preferred configuration, the secondary gas line is fluidically connected to a gas store for the secondary gas.

### BRIEF DESCRIPTION OF THE DRAWINGS

One exemplary embodiment of the invention is explained in more detail with reference to the drawing.

### DETAILED DESCRIPTION OF INVENTION

Herein, the single FIGURE illustrates an electrolysis system 1 comprising an electrolyzer 2. The electrolysis system 1 also has a first gas separation device 4 on the oxygen side and a second gas separation device 6 on the hydrogen side. The electrolyzer 2 is connected to the first gas separation device 4 via a first product gas line 8 and to the second gas separation device 6 via a second product gas line 10. Accordingly, a mixture of water and oxygen is transported via the first product gas line 8. A mixture of water and hydrogen is conducted out of the electrolyzer 2 through the second product gas line 10. A liquid/gas separation subsequently takes place in the respective gas separation device 4, 6.

Furthermore, water from the first gas separation device 4 is recycled into the electrolyzer 2 via a water return line 12.

The water from the second gas separation device 6 is conducted into a water supply line 14 of the electrolyzer 2.

In practice, the oxygen gas stream in the first product gas line 8 comprises small amounts of hydrogen and the hydrogen gas stream in the second product gas line 8 comprises small amounts of oxygen. In order to remove these foreign gases, i.e. to purify the product gases oxygen 16 and hydrogen 18, a recombiner 20, 22 is connected downstream of the respective gas separation device 4, 6, in which recombiner the gaseous hydrogen is catalytically oxidized with the gaseous oxygen to form water.

Part of the respective product gas 16, 18 processed in this way is recycled into the respective gas separation device 4, 6 via a secondary gas line 24. Integrated in the secondary gas line 24 here is a fan 26 which increases the pressure of the purified product gas, oxygen or hydrogen, before the gas separation device 4, 6. Due to the branched-off, pure product gas, the foreign gas concentration in the product gas stream in the product gas lines 8, 12 that is to be treated is reduced by the increase in the overall volumetric flow rate.

It is further possible to ensure particularly flexible operation by determining the foreign gas concentration in the respective product gas stream and varying the volumetric flow rate of the secondary gas depending on this foreign gas concentration. For this purpose, measuring devices, which however are not illustrated in the FIGURE, are attached to the product gas lines 8, 12.

A further option is to temporarily store the purified product gas, which is provided as secondary gas, in a gas store and to recycle it into the gas separator when the electrolysis system is started up. The gas store, not illustrated in greater detail, is in particular fluidically connected to the respective secondary gas line 24.

As an alternative to supplying the secondary gas into the gas separation device, said secondary gas may be conducted into the outlet region from the electrolyzer 2 and/or into the inlet region of the electrolyzer 2. As a further alternative, it is also conceivable to supply an inert gas, such as nitrogen, as secondary gas instead of a purified product gas at least on the oxygen side.

In the exemplary embodiment illustrated, the product gas stream is mixed with a secondary gas both on the oxygen side and on the hydrogen side. However, it is possible to supply the secondary gas to only one product side, for example only to the oxygen side.

1. A method for operating an electrolysis system comprising an electrolyzer for generating hydrogen and oxygen as product gases, the method comprising:
discharging the product gas streams from the electrolyzer, and
mixing a secondary gas with at least one of the product gas streams.

2. The method as claimed in claim 1,
wherein the secondary gas comprises the same product gas as in the product gas stream with which it is mixed and/or comprises an inert gas.

3. The method as claimed in claim 1,
wherein the secondary gas is a gas which is generated in the electrolysis system and is purified and recycled.

4. The method as claimed in claim 3,
wherein at least part of the product gas stream is purified after a gas separation device and used as secondary gas.

5. The method as claimed in claim 4,
wherein the secondary gas is recycled into the gas separation device under pressure.

6. The method as claimed in claim 1,
wherein a foreign gas concentration in the product gas stream which is mixed with the secondary gas is determined and a volumetric flow rate of the secondary gas is adjusted depending on the foreign gas concentration.

7. The method as claimed in claim 1,
wherein at least part of a product gas is branched off and temporarily stored in a gas store, wherein the stored product gas is recycled as secondary gas when the electrolysis system is started up.

8. An electrolysis system comprising:
an electrolyzer for generating hydrogen and oxygen as product gases,
a first product gas line and a second product gas line for discharging the product gases from the electrolyzer, and
a secondary gas line, by which a secondary gas is mixed with at least one of the product gas streams in one of the product gas lines.

9. The electrolysis system as claimed in claim 8,
wherein the secondary gas line opens into a gas separation device downstream of the electrolyzer.

10. The electrolysis system as claimed in claim 9,
wherein the secondary gas line is branched off from the at least one product gas line after the gas separation device.

11. The electrolysis system as claimed in claim 8,
wherein a recombiner is arranged on the at least one product gas line.

12. The electrolysis system as claimed in claim 8,
wherein the secondary gas line comprises a fan.

13. The electrolysis system as claimed in claim 8, further comprising:
a measuring device for measuring a foreign gas concentration in the product gas stream which is mixed with the secondary gas, and
a control device suitable for adjusting a volumetric flow rate of the secondary gas depending on the foreign gas concentration.

14. The electrolysis system as claimed in claim 8,
wherein the secondary gas line is fluidically connected to a gas store for the secondary gas.
